(19) United States
(12) Patent Application Publication
(10) Pub. No.: US 2006/0267774 A1
(43) Pub. Date: Nov. 30, 2006

(54) Transponder overmolded with ethylene copolymers

(76) Inventors: Stewart C. Feinberg, Exton, PA (US); John Chu Chen, Hockessin, DE (US); David J. Walsh, Chadds Ford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/388,861

(22) Filed: Mar. 24, 2006

Related U.S. Application Data
(60) Provisional application No. 60/664,745, filed on Mar. 24, 2005.

(51) Int. Cl. G08B 13/14

(52) U.S. Cl. 340/572.8

(57) ABSTRACT

An overmolded transponder is at least partially overmolded with an overmolding composition comprising an ethylene copolymer. The overmolding composition may optionally comprise one or both of a second polymer such as polyethylene or a filler. The overmolded transponder can serve as a radio frequency identification device, for example, such as a bolus transponder for identification of animals.

### CROSS-REFERENCE TO RELATED APPLICATION

This application claims priority under 35 U.S.C. § 120 to U.S. Provisional Application No. 60/664,745, filed on Mar. 24, 2005, which is incorporated herein by reference in its entirety.

### BACKGROUND OF THE INVENTION

1. Field of the Invention

The invention relates to the use of ethylene copolymers for overmolding devices having ferrite cores, powdered metal cores, and high-energy product magnet cores, and products made by overmolding electronic components incorporating such core materials.

2. Description of the Related Art

Several patents and publications are cited in this description in order to more fully describe the state of the art to which this invention pertains. The entire disclosure of each of these patents and publications is incorporated by reference herein.

Ferrite cores, powdered metal cores and high energy product magnets such as samarium cobalt and neodymium-iron-boron magnets have certain advantageous magnetic and electric field properties making them ideal for use in certain types of electronic components and circuitry. These types of materials are frangible, yet the materials can be fabricated into a variety of shapes and generally exhibit good mechanical characteristics under compression loads. However, these frangible materials are generally weak in tensile strength, tending to crack or fracture when subject to relatively modest tensile loading, binding loads or impact loading. Cracks and fractures within the fabricated frangible materials can substantially decrease the beneficial magnetic and electric field properties, negatively impacting their desirable characteristics and reducing their lifetime. They may also be affected by the exposure to moisture and/or acidic conditions encountered when used in vivo. Thus, maximum utilization of these types of frangible materials requires consideration of and accommodation for their limiting physical properties.

An example application that can benefit from the use of a ferrite core as part of an electronic circuit is an electronic identification (EID) or radio frequency identification (RFID) transponder circuit used in EID or RFID systems. EID and RFID systems generally include a “reader”. The reader has two functions, and the apparatus that accomplishes each of these the functions may be housed together in a single unit. The first apparatus is an emitter that is capable of emitting a high frequency signal in the kilohertz (kHz) frequency band range or an ultra-high frequency signal in the megahertz (mHz) frequency band range. The emitted signal from the reader is received by a transponder that is activated in some manner upon detection or receipt of the emitted signal from the reader. The second apparatus in the reader is a receiver. In EID and RFID systems, the transponder generates a signal that is received by the receiver in the reader, or inductively couples to the receiver in the reader, to allow the reader to obtain identification codes or data from a memory in the transponder.

The transponder of an EID or RFID system includes signal processing circuitry which is attached to an antenna, such as a coil. For certain applications, the coil may be wrapped about a ferrite, powdered metal, or magnetic core. The signal processing circuitry can include a number of different operational components including integrated circuits as known in the art. Moreover, many, if not all, of the operational components can be fabricated in a single integrated circuit which is the principal component of the signal processing circuitry of EID and RFID devices.

Many of the types of EID and RFID transponders presently in use have particular benefits resulting from their ability to be embedded or implanted within an object to be identified. Preferably, these transponders are hidden from visual inspection or detection. For such applications, the entire transponder is preferably be encased in a sealed member. The sealed member allows the transponder to be implanted into biological specimens so that they may be so identified, or allows the transponder to be used in submerged, corrosive or otherwise abusive environments.

The use of EID and RFID devices in biological applications, such as the identification of livestock, has been under investigation. Concerns about the safety of the food supply from such threats as mad cow disease or terrorism are increasing. A “bolus” EID or RFID device is one that can be swallowed by a cow, sheep or other ruminant and remain in the animal throughout its lifetime for removal after it is slaughtered. Such bolus transponders can be used for identification and tracking of individual animals through the commercial food production chain.

To obtain acceptance and use of the EID or RFID bolus transponder devices for ruminant animals, however, the devices must be designed and fabricated with an understanding of the physical and economic requirements of the livestock application. For example, EID circuitry can be very small and lightweight, requiring merely the integrated circuit and antenna and few other components. Therefore, the bolus transponder generally requires additional weight, so that it will be retained in the animal's digestive tract, and preferably the bolus is capable of surviving the conditions present in the reticulum of the animal. See, e.g., U.S. Pat. Nos. 4,262,632; 4,262,632; 4,262,632; 5,025,550; 5,211,129; 5,223,851; 5,281,855 and 5,482,008.

In addition, a bolus transponder in a ruminant animal's digestive tract offers several advantages over the small transponders that are currently implanted under some pets' skin. Specifically, bolus transponders are larger, and therefore they can read weaker signals and emit more powerful signals. Thus, individual animals can be identified at greater distances. For example, a veterinary technician may have to hold a reader against a pet's skin to receive a signal from a transponder that is typically about the size of a grain of rice. The signal may go undetected, if the tiny transponder is not implanted at the expected location, or if its position has changed since it was implanted. In contrast, a bolus transmitter in a ruminant's stomach can emit a signal that is readable at distances of inches or even feet away from the animal. This greater distance permits the design of a larger number of receiving systems for the bolus transponders' signals.

In making some known encapsulated transponders, a transponder circuitry is assembled and inserted into a glass, ceramic, or metallic cylinder, one end of which is already sealed. The open end of a glass-type cylinder is generally sealed by melting with a flame, to create a hermetically sealed capsule. It is also known to use an epoxy material to bond the circuitry of the transponder to the interior surface of the capsule. See, e.g., U.S. Pat. Nos. 5,482,008 and 5,963,132.

However, glass or ceramic encased boluses are relatively fragile and can be damaged if they are dropped or even rattled together during shipping. Thus, the cost and fragile physical characteristics of the ceramics are likely to have a negative impact on their commercial acceptance. Likewise, some metal casings are susceptible to chemical degradation in oxidizing, acidic, or biologically active environments. The metals' dissolution in an animal's digestive tract may also endanger the animal's health.

Methods to prepare RFID devices by overmolding transponders with encapsulants made from injection moldable materials such as plastic, polymeric or epoxy materials are known. See, e.g., U.S. Pat. No. 6,441,741. Many of these materials, however, are not sufficiently durable in abusive environments such as the high moisture conditions or elevated temperatures or upon thermal cycling under which bolus devices are used in veterinary applications.

Thus, it is desirable to develop materials for encapsulants that are superior in strength, impact resistance, and toughness to known ceramic materials, and that are more durable under in vivo conditions than known plastic encapsulants.

### SUMMARY OF THE INVENTION

The invention includes an overmolded transponder. The transponder comprises an EID circuit or, preferably, an RFID circuit that is at least partially overmolded with an overmolding composition. The overmolding composition comprises or is produced from an ethylene copolymer and, optionally, a filler or weighting material. The ethylene copolymer comprises repeat units derived from ethylene and a polar comonomer; the comonomer may be selected from C₃ to C₈ α,β-ethylenically unsaturated carboxylic acid, alkyl (meth)acrylate, (meth)acrylic acid, vinyl acetate, carbon monoxide, maleic acid monoester, maleic acid diester, or combinations of two or more thereof. If the ethylene copolymer comprises acid groups, the acid groups are optionally at least partially neutralized.

The invention also includes an overmolding blend comprising the composition above and a blending polymer that is different from the ethylene copolymer. The blending polymer may be selected from polypropylene or any of the materials that are suitable for use as the ethylene copolymer.

The invention further includes the use of the transponder as a bolus transponder to be placed within an animal to serve as a marker device in an identification system to identify the animal.

### DETAILED DESCRIPTION OF THE INVENTION

The following definitions apply to the terms as used throughout this specification, unless otherwise limited in specific instances.

Although “radiofrequency identification devices (RFIDs)” are a preferred subset of “electronic identification devices (EIDs)”, the terms are generally used interchangeably herein.

The term “(meth)acrylic”, as used herein, alone or in combined form, such as “(meth)acrylate”, refers to acrylic and/or methacrylic, for example, acrylic acid and/or methacrylic acid, or alkyl acrylate and/or alkyl methacrylate.

The terms “finite amount” and “finite value”, as used herein, refer to an amount that is greater than zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. The overmolded transponder of the invention includes an EID or, preferably, an RFID circuit that is at least partially overmolded with an overmolding composition.

The overmolding composition is used to produce a casing for the EID or RFID. The casing comprises the overmolding composition. Preferably, the casing consists essentially of the overmolding composition. The casing preferably is able to withstand the acidic environment in the digestive tract of a ruminant animal, is impervious to the microbes and enzymes that are active within the digestive tract of the ruminant animal, and is neutral to the biologic fauna, microbes and enzymes. The overmolding composition preferably also has certain physical and mechanical properties that allow ease in preparation, shipping and handling of the bolus transponder before administration to the ruminant animal.

Ethylene Copolymers

The overmolding composition comprises an ethylene copolymer. Without limitation, suitable ethylene copolymers include the following.

Acid Copolymers

The acid copolymers are preferably “direct” acid copolymers comprising repeat units derived from an α-olefin such as ethylene, at least one comonomer derived from a C₃₋₈ α,β-ethylenically unsaturated carboxylic acid, and optionally a third softening comonomer. “Softening”, means that the crystallinity is disrupted (the polymer is made less crystalline).

An ethylene acid copolymer can be described as E/X/Y copolymers where E is ethylene, X is derived from at least one α,β-ethylenically unsaturated carboxylic acid, and Y is a softening comonomer. Suitable minimum levels of X are 3, 4, or 5 wt %, and suitable maximum levels are 35, 25, or 20 wt %, based on the total weight of the E/X/Y copolymer. Suitable minimum levels of Y are 0, a finite amount, 0.1 wt %, or 5 wt %, and suitable maximum levels are 35 or 30 wt %, based on the total weight of the E/X/Y copolymer.

Suitable X can be an unsaturated acid or its ester such as acrylic acid, methacrylic acid, maleic acid, fumaric acid, itaconic acid, maleic acid, maleic acid half-ester, fumaric acid monoester, or combinations of two or more thereof. Esters can be derived from C₁ to C₄ alcohols such as, for example, methyl, ethyl, n-propyl, isopropyl, and n-butyl alcohols. Acrylic and methacrylic acid are preferred.

Suitable “softening” comonomers for use as Y include alkyl acrylate, alkyl methacrylate, or both where the alkyl group ranges from 1 to 8 carbon atoms. Preferred are those wherein the alkyl groups have from 1 to 4 carbon atoms.

Specific examples of suitable acid copolymers include ethylene/(meth)acrylic acid copolymers such as ethylene/(meth)acrylic acid/n-butyl (meth)acrylate, ethylene/(meth)acrylic acid/iso-butyl (meth)acrylate, ethylene/(meth)acrylic acid/methyl (meth)acrylate, ethylene/(meth)acrylic acid/ethyl (meth)acrylate terpolymer, ethylene/maleic acid, ethylene/maleic acid monoester, ethylene/maleic acid monoester/n-butyl (meth)acrylate, ethylene/maleic acid monoester/methyl (meth)acrylate, ethylene/maleic acid monoester/ethyl (meth)acrylate, or combinations of two or more thereof.

Several preferred acid copolymers for use in the present invention are commercially available. These include Nucrel® polymers, available from E.I. du Pont de Nemours & Co. of Wilmington, Del. (hereinafter “DuPont”), and Escor™ polymers, available from ExxonMobil Chemical Company of Houston, Tex., and the like.

Methods of preparing acid copolymers of ethylene are well known in the art. For example, acid copolymers may be prepared by the method disclosed in U.S. Pat. No. 4,351,931, issued to Armitage. This patent describes acid copolymers of ethylene comprising up to 90 weight percent ethylene. In addition, U.S. Pat. No. 5,028,674, issued to Hatch et al., discloses improved methods of synthesizing acid copolymers of ethylene when polar comonomers such as (meth)acrylic acid are incorporated into the copolymer, particularly at levels higher than 10 weight percent. Finally, U.S. Pat. No. 4,248,990, issued to Pieski, describes the preparation and properties of acid copolymers synthesized at low polymerization temperatures and normal pressures.

Ethylene-acid copolymers with high levels of acid (X) are difficult to prepare in continuous polymerizers because of monomer-polymer phase separation. This difficulty can be avoided however by use of “co-solvent technology” as described in U.S. Pat. No. 5,028,674, or by employing somewhat higher pressures than those at which copolymers with lower acid can be prepared.

Ionomers

The ionomers include partially neutralized acid copolymers such as ethylene/(meth)acrylic acid copolymers. The acid copolymers may be neutralized to any level that does not result in an intractable (not melt processible) polymer, or one without useful physical properties. The level of neutralization can be from about 15 to about 90% or about 40 to about 75% of the acid moieties of the acid copolymer. For acid copolymers having a high acid level (for example, over 15 weight %), the percent neutralization can be lower to retain melt processibility.

Preferred cations include, without limitation, an alkali metal cation, an alkaline earth metal cation, a transition metal cation, and combinations of two or more thereof. Particularly preferred are lithium, sodium, potassium, magnesium, calcium, and zinc cations, and combinations thereof.

Several preferred isomers for use in the present invention are commercially available. These include Surlyn® copolymers, available from DuPont.

Ethylene/Vinyl Acetate Copolymers

The overmolding composition or blend may comprise at least one ethylene/vinyl acetate copolymer including repeat units derived from ethylene, vinyl acetate, and optionally an additional comonomer. The amount of vinyl acetate incorporated into ethylene/vinyl acetate copolymer can vary from about 0.1 or about 5 up to about 45, or 2 to 45, or 6 to 30, % of the total copolymer or even higher.

An ethylene/vinyl acetate copolymer may optionally be modified by methods well known in the art, including modification with an unsaturated carboxylic acid or its derivatives, such as maleic anhydride or maleic acid. The ethylene/vinyl acetate copolymer preferably has a melt flow rate, measured in accordance with ASTM D-1238, of from 0.1 to 60 g/10 minutes, and especially from 0.3 to 30 g/10 minutes. A mixture of two or more different ethylene/vinyl acetate copolymers can be used in the overmolding composition or blend.

Several preferred EVA copolymers for use in the present invention are commercially available. These include Elvax® copolymers, available from DuPont.

Methods of preparing EVA copolymers are well known in the art. See, for example, the Modern Plastics Encyclopedia, McGraw Hill, (New York, 1994) or the Wiley Encyclopedia of Packaging Technology, 2d edition, A. L. Brody and K. S. Marsh, Eds., Wiley-Interscience (Hoboken, 1997).

Ethylene/Alkyl (Meth)acrylate Copolymers

The ethylene copolymer may be a copolymer of ethylene and an alkyl (meth)acrylate. Any known ethylene alkyl (meth)acrylate copolymer is suitable for use in the present invention.

The amount of the alkyl (meth)acrylate comonomer can vary from about 0.1, 5, or 10 wt % up to about 28, 35, or 45 wt % or even higher, based on the total weight of the ethylene copolymer. The relative amount and choice of the alkyl group present can be viewed as to attain the relative degrees of crystallinity disruption and incorporation of polarity into the ethylene copolymers. C1 to C8 alkyl groups are preferred. More preferably, the alkyl group is methyl, ethyl or n-butyl, and n-butyl groups are particularly preferred.

Ethylene/alkyl acrylate (or methacrylate) copolymers can be prepared by processes well known in the polymer art using either autoclave or tubular reactors such as those disclosed in U.S. Pat. Nos. 5,028,674; 2,897,183; 3,350,372; 3,756,996; and 5,532,066. Of note is a “tubular reactor-produced” ethylene/alkyl (meth)acrylate copolymer.

The ethylene/alkyl acrylate (or methacrylate) copolymers can vary in molecular weight. Their melt index preferably ranges from a fraction of a gram up to about ten grams per ten minutes, as measured by ASTM D1238. Lower molecular weight materials, with correspondingly higher melt indices, may be useful in some embodiments, however.

Several preferred ethylene/alkyl(meth)acrylate copolymers for use in the present invention are commercially available. These include Elvaloy® AC polymers, available from DuPont.

Methods of preparing ethylene/alkyl(meth)acrylate copolymers are well known in the art. See, for example, the Modern Plastics Encyclopedia and the Wiley Encyclopedia of Packaging Technology.

Other Ethylene Copolymers

Other suitable ethylene copolymers include those with comonomers selected from carbon monoxide, maleic acid monoester, maleic acid diester, or combinations of two or more thereof. Specific examples of other suitable ethylene copolymers include copolymers of ethylene, n-butyl acrylate, and carbon monoxide (E/nBA/CO).

Several other ethylene copolymers suitable for use in the present invention are commercially available. These include Elvaloy®, Fusabond®, and Vamac® resins, available from DuPont.

Methods of preparing these ethylene copolymers are well known in the art. See, for example, the Modern Plastics Encyclopedia and the Wiley Encyclopedia of Packaging Technology.

Blending Polymer

The overmolding composition may optionally include a blending polymer that is different from the ethylene copolymer. Suitable materials for use as the blending polymer include, without limitation, those defined above for use as the ethylene copolymer.

The blending polymer may also comprise of be produced from a polyolefin. Any known polyolefin may be used in the present invention. The polyolefin may be a homopolymer or a copolymer of two or more monomers. The polyolefin molecules may be straight chained, branched, or grafted. Preferred polyolefins include polyethylenes and polypropylenes.

Suitable polyethylenes include high-density polyethylene (HDPE), linear low density polyethylene (LLDPE), very low or ultralow density polyethylenes (VLDPE or ULDPE) and branched polyethylenes such as low density polyethylene (LDPE). The densities of polyethylenes preferably range from about 0.865 g/cc to about 0.970 g/cc.

Also suitable are polyethylenes comprising, for example, one or more α-olefins having 3 to about 20 carbon atoms such as propylene, 1-butene, 1-hexene, 4-methyl-1-pentene, 1-octene, 1-decene, 1-tetradecene, 1-octadecene, and the like. Also suitable is an ethylene propylene elastomer containing a small amount of unsaturated compounds having a double bond; or a small amount of a diolefin component such as butadiene, norbornadiene, hexadiene or isoprene; or a terpolymer such as ethylene/propylene/diene monomer (EPDM).

A polyethylene of note is high-density polyethylene (HDPE). A specific example of a high-density polyethylene has a melt index (MI) of 3.0 g/10 min. One such HDPE is commercially available from the Equistar Company of Houston, Tex., as Alathon 7030.

Several preferred polyethylenes for use in the present invention are commercially available in addition, polyethylenes can be prepared by a variety of methods, including well-known Ziegler-Natta catalyst polymerization (see, e.g., U.S. Pat. Nos. 4,076,698 and 3,645,992), metallocene catalyst polymerization (see, e.g., U.S. Pat. Nos. 5,198,401 and 5,405,922) and by free radical polymerization. See also, more generally, the Modern Plastics Encyclopedia or the Wiley Encyclopedia of Packaging Technology.

Also suitable is polypropylene, including homopolymers, random copolymers, block copolymers and terpolymers of propylene. Suitable comonomers include other olefins such as ethylene, 1-butene, 2-butene, the isomers of pentene, and the like. Preferred are copolymers of propylene with ethylene. Suitable terpolymers of propylene include copolymers of propylene with ethylene and one other olefin.

Polypropylene may also be prepared by Ziegler-Natta catalyst polymerization, metallocene catalyst polymerization, or free radical polymerization. See, generally, the Modern Plastics Encyclopedia or the Wiley Encyclopedia of Packaging Technology.

Fillers and Additives

The overmolding composition may also optionally include one or more fillers or weighting materials to adjust the properties of the finished casing and/or transponder. For example, it is believed that the weight of the bolus contributes to its maintaining its position in the animal's digestive tract. Accordingly, the total weight of the bolus transponder is preferably at least 60 g. In order to attain this weight without adding undue volume to the overmolding, and without unduly compromising its impermeability, it is preferable that any filler used in the bolus transponder overmolding have a specific gravity of at least 1.5 or at least 1.7 or at least 2.

Suitable fillers include barium sulfate, zinc oxide, calcium carbonate, titanium dioxide, carbon black, kaolin, magnesium aluminum silicate, silica, iron oxide, glass spheres, and wollastonite. Purified USP grade barium sulfate or barite fines are preferred as these materials have been blended with a carnauba wax and a medicament to form boluses for ruminant animals as disclosed in U.S. Pat. No. 5,322,692. The filler is preferably present in an amount that adjusts the specific gravity of the overmolded casing and the resulting transponder to desired ranges. For example, the filler may be present in a range from about 5 to about 80 wt %, based on the total weight of the overmolding composition.

The incorporation of the filler(s) into the composition can be carried out by any suitable process such as, for example, by dry blending, by extruding a mixture of the various constituents, by the conventional masterbatch technique, or the like.

The overmolding composition may also include one or more additives such as, for example, impact modifiers, antioxidants and thermal stabilizers, ultraviolet (UV) light stabilizers, pigments and dyes, slip agents, anti-slip agents, plasticizers, other processing aids, and the like. Suitable levels of these additives and methods of incorporating the additives into polymer compositions will be available to those of skill in the art. Often, the additives are present in a finite amount or at a level of at least about 0.01 or 0.1 wt %, or up to about 15 or 20 wt %, based on the total weight of the overmolding composition. See, generally, the Modern Plastics Encyclopedia or the Wiley Encyclopedia of Packaging Technology for further information about fillers, additives, formulating and compounding.

Overmolding Compositions

Of note is an overmolding composition comprising (a) at least one ethylene copolymer derived from copolymerization of ethylene and a C₃ to C₈ α,β-ethylenically unsaturated carboxylic acid (e.g. (meth)acrylic acid), and optionally at least one additional alkyl (meth)acrylate comonomer, wherein the acid moieties are at least partially neutralized; and (b) a filler comprising barium sulfate.

Also of note is a blend comprising polyethylene and at least one ethylene/alkyl (meth)acrylate copolymer.

Also of note is a blend composition comprising polyethylene and at least one ethylene/alkyl (meth)acrylic acid ionomer.

Also of note is a blend composition comprising polyethylene and at least one ethylene/alkyl acrylate (or methacrylate) copolymer. Blends can be prepared with any proportion of polyethylene to ethylene/alkyl (meth)acrylate, such as blends having a ratio of polyethylene to ethylene/alkyl (meth)acrylate of from 1:9 to 9:1. Preferred compositions include blends wherein the ratio of polyethylene to ethylene/alkyl (meth)acrylate copolymer is from 1:1 to 4:1 (i.e. polyethylene is present in from 50 to 80 weight % of the two-component mixture). Of note are blends wherein the ratio of polyethylene to ethylene/alkyl (meth)acrylate copolymer is from 3:2 to 3:1 (i.e. polyethylene is present in from 60 to 75 weight % of the two-component mixture).

RFID Transponder Devices

The overmolded transponder of the invention includes an EID or RFID transponder that is overmolded with the overmolding composition. Typically, the transponder includes an antenna, a transponder circuit, a core element, and an overmolded casing. The transponder circuit includes signal processing circuitry that is electrically interconnected to the antenna. The core element is the structure on which the antenna and the transponder circuit are mounted. The overmolded casing comprises or is produced from the overmolding composition disclosed above.

Identification systems such as those using RFID or EID typically consist of a marker device (e.g. a transponder) that remains with the article or animal to be identified and a reader that is capable of detecting and recognizing the marker device, thereby verifying and authenticating the identity of the article or animal. Certain types of “active” RFID transponders may include a power source such as a battery that may also be attached to the circuit board and the integrated circuit. The battery is used to power the signal processing circuit during operation of the transponder. Other types of transponders such as “Half Duplex” (“HDX”) transponders include an element for receiving energy from the reader, such as a coil, and elements for converting and storing the energy, for example a transformer/capacitor circuit. In an HDX system, the emitted signal generated by the reader is cycled on and off, inductively coupling to the coil when in the emitting cycle to charge the capacitor. When the emitted signal from the reader stops, the capacitor discharges to the circuitry of the transponder to power the transponder that then can emit or generate a signal that is received by the reader.

A “Full Duplex” (“FDX”) system, by comparison, includes a transponder that generally does not include either a battery or an element for storing energy. Instead, in an FDX transponder, the energy in the field emitted by the reader is inductively coupled into the antenna or coil of the transponder and passed through a rectifier to obtain power to drive the signal processing circuitry of the transponder and generate a response to the reader concurrently with the emission of the emitted signal from the reader.

Many different circuit designs for active, HDX and FDX transponders are known in the art. A transponder may also include signal processing circuitry such as an integrated circuit mounted on a circuit board together with other circuit elements such as a capacitor. The integrated circuit and capacitor can be affixed to the circuit board and electrically coupled to a wire formed into a coil, at the leads or ends of the wire. The coil may be wrapped about a bobbin and then positioned over a core with the circuit board affixed to an end of the core to form a transponder assembly. The transponder assembly can be overmolded within an injection molding composition as disclosed herein to form a bolus transponder.

The relative axial location of the coil about the core may be important to the optimal operation of the transponder. The transponder may include a tuned coil and capacitor combination. Generally, in a transponder, tuning is accomplished by matching the length of the wire forming the coil to the capacitance of the capacitor. However, when the wire is wrapped around a bobbin and installed over the core, the exact length of wire, as well as its inductance, may not be as well controlled during design and fabrication so as to allow matching of the inductance of the coil to the capacitance of the capacitor in order to tune the circuit of the transponder. If the transponder is not properly tuned, the reading and data transfer capabilities of the transponder may be diminished.

By the proper axial placement of the core within the coil, the transponder can be tuned even without optimizing the length of the wire, as the inductance of the coil changes due to the axial positioning of the ferrite core. For a given set of design parameters for a ferrite core and coil combination, including the core's circumference and length as well as the length of the wire and the capacitance of the capacitor, a tuned transponder assembly can be fabricated by moving the coil axially along the long axis of the ferrite core until a tuned inductor/capacitor system is established and then securing the bobbin with coil to the ferrite core during the manufacturing process.

Overmolding

The overmolded transponder can be produced by placing the transponder within a cavity formed by mold tooling in an injection molding machine; and injecting the overmolding composition into the cavity so as to encase the transponder at least partially.

More specifically, following assembly of the circuitry of a transponder assembly, the transponder assembly is transferred to an injection-molding machine and is placed within the mold tooling. The mold tooling when closed defines a cavity sized to receive the transponder assembly in preparation for overmolding with the injection molding material. The interior walls of the mold tooling can have surface features to define a variety of shapes or patterns on the outer surface of the completed transponder, as may be beneficial to particular applications. The potential variations for the design of the exterior shape of the completed transponder, thus, for example, may be cylindrical, bullet shaped, tapered at opposite ends or a flattened oval, and the outer walls may be smooth, rough or bumpy, depending on the intended application. Of note are bolus configurations that are substantially cylindrical.

The overmolded casings of the present invention can have a wall thickness of between about 0.005 inches to over one inch, or less than 0.5 inches. Depending on the desired exterior shape of the completed assembly and the shape of the core, the wall thickness of the casing may be uniform or may vary at various locations about the core. An example of a bolus transponder of the invention may have the shape of a cylinder about three inches long (7.6 cm) with a diameter of about 0.5 inches (1.3 cm), with an average thickness of the casing wall of about 0.125 inches (3 mm).

The mold tooling typically includes inwardly projecting pins, which serve to position and secure the transponder assembly within the tooling during the injection process. The pins can be retracted by pressure response pin retractors into the mold tooling near the end of the injection cycle. A sprue through which the injection molding material is injected by an injection-molding machine is also present in the mold tooling. The mold tooling may include guide pins that align with and engage guide pin receiving holes when the mold tooling is closed, to maintain the alignment of the mold tooling during the injection cycle.

When the heated and plasticized molding material is injected under pressure by the injection molding machine, the plasticized molding material flows in through the sprue and impinges upon the end of the core, and axially compresses the core against pins that are positioned to contact the opposite end of the transponder assembly.

The molding material can then flow radially outward along the end of the ferrite core. When enough molding material has been injected to fill up the end of the cavity, the advancing face of the molding material proceeds longitudinally along the radially outer surface of the transponder assembly. This overmolding injection process only subjects the core to compressive loads, and does not subject the core to tensile loading at any time during the entire injection cycle. Thus, by the overmolding injection process of the present invention the core may not be damaged in a manner that may diminish the electrical or magnetic properties of the core.

When the mold cavity is completely filled with the plasticized molding material, the internal pressure within the cavity increases. The pins that position the transponder assembly within the cavity and are connected to pin retractors, which are pressure sensitive. When the pressure in the mold cavity reaches a predetermined level, the pins retract into the mold cavity wall, and the molding material fills the space vacated by the pins. Since the molding material has already encased the transponder, however, the molding material may hold the transponder in place during the curing or hardening stage of the injection overmolding cycle. Upon completion of the overmolding process, the mold tooling is opened and the completed transponder is ejected.

An alternative transponder does not include a core. Instead, the wire forming the coil is wrapped about the circuit board upon which the integrated circuit and capacitor are mounted and interconnected to the circuit board and the integrated circuit via leads. This transponder is generally much smaller than the assembly with a core and does not have the added weight of the core. This transponder can also be overmolded in a process similar to the process disclosed above. Again, the exterior configuration of the resulting overmolded transponder assembly may be any desired shape, limited only by the moldability of the shape. This type of transponder, due to its smaller size, may be suited for applications in which the device is implanted into an organism. For example, the transponder may be inserted under the skin of an animal, or even a person, for identification and tracking purposes. Alternatively, the transponder may be encased in a glass material by known methods, and then overmolded with the materials described herein to provide the strength, impact resistance and toughness that are lacking in typical glass encased transponders.

A frangible core may be overmolded generally in the same manner disclosed above. In this embodiment, the frangible core may be formed from ferrite, powdered metals or high-energy product magnets such as samarium cobalt and neodymium-iron-boron materials.

The overmolding process encapsulates the frangible core in a protective shell, which allows the frangible core materials to be used in applications that the frangible physical property of such materials would not otherwise allow. For example, samarium cobalt and neodymium-iron-boron magnets encased in a relatively thin coating of the overmolded materials may be used in objects subject to shock, impact or vibrational loads which may otherwise lead to the cracking, fracturing or other physical and magnetic degradation of the magnetic core.

Alternative designs for the mold tooling have one or more centering elements designed with a center portion such as a sleeve designed to fit around the core. The centering elements may also include radially outwardly projecting fins or pins, which center the transponder within the tooling during the overmolding process, and thereby eliminate the need for the retractable pins described above. The centering element may be formed from plastic, or from the same type of material used to overmold the transponder. The centering element may be a part of, or connected, to the bobbin disclosed above where the pins simply extend radially outward from one end or both ends of the bobbin.

Alternatively, the transponder may have an overmolded casing comprising more than one layer of thermoplastic material. In such cases, a first thermoplastic material may be molded over the transponder circuitry and a second thermoplastic material may be molded over the first material.

For many of the foregoing types of injection molding materials such as those whose density is increased by the addition of a filler, the material in its plasticized state for the injection process has a low viscosity. Injection molding such materials may require high injection pressures in turn leading to high stress forces being imposed on the core materials during the injection process. Minimizing or eliminating any loading other than compressive loading on the frangible cores during the injection process is preferred.

For general information about EID and RFID systems, transponders, and overmolding, see U.S. Pat. No. 6,441,741.

The following examples are provided to describe the invention in further detail. These examples, which set forth a preferred mode presently contemplated for carrying out the invention, are intended to illustrate and not to limit the invention.

### COMPARATIVE EXAMPLES C1 AND C5 AND EXAMPLES 2-4

Materials Used

HDPE-1: a high-density polyethylene, with a melt index (MI) of 3.0; available as Alathon 7030 from the Equistar Company of Houston, Tex. Ionomer-1: an ethylene/methacrylic acid copolymer (10.5% MAA) with 68% of available carboxylic acid groups neutralized with zinc counterions; MI of 1.1. This material is available from DuPont under the Surlyn® trademark.

Ionomer-2: an ethylene/methacrylic acid copolymer (8.7% MAA) with 18% of available carboxylic acid groups neutralized with zinc counterions; MI of 5.0. This material is available from DuPont under the Surlyn® trademark.

EBA-7: an ethylene/n-butyl acrylate copolymer (35% nBA); MI of 1.1. This polymer is available from DuPont under the Elvaloy® trademark.

Two-component compositions were prepared from the materials listed above by standard melt-blending techniques. Compositions C1 and 3 are single component compositions.

Composition C1: HDPE-1

Composition 2: 62:37 HDPE-1 :Ionomer-1

Composition 3: Ionomer-2

Composition 4: 60:39 HDPE-1:EBA-7

Standard transponder circuits, each circuit consisting of a chip with identification information attached to a ferrite core and a wire coil, were prepared. A magnetic coil could activate the chip to provide the identification information. The compositions were injection molded around the standard transponder circuits to prepare test bolus transponders. The transponders were cylindrical, about 3 inches (7.6 cm) long and about 0.5 inch (1.3 cm) in diameter.

Encapsulated bolus transponders (50 of each composition) were evaluated using an environmental test chamber suitable for controlling an eight-hour temperature and humidity cycle as described below. Five un-encapsulated transponders were also tested as controls (C5). From a starting condition of 23° C. and 50% relative humidity (RH) the transponders were cooled (over about 30 minutes) to −40° C. and otherwise uncontrolled low humidity. These conditions were held for one hour. The transponders were then heated (over about 60 minutes) to 70° C. and 95% RH. These conditions were held for four hours. Finally, the transponders were returned (over about 30 minutes) to the starting conditions. These conditions were held for one hour to complete a single cycle.

The transponders were subjected to multiple consecutive cycles to estimate their lifetimes under these conditions. Periodically, the transponders were tested for activity by removing them from the test chamber, drying them and measuring their response to a reader. Active transponders were returned to the chamber for further cycles. Inactive transponders were not returned to the test chamber. In some cases, inactive transponders regained activity on standing under ambient conditions for a period of time (not recorded). Table 1 shows the percentage of transponders still active after a given number of cycles. After the most durable transponders had undergone 87 temperature and humidity cycles, all the transponders were returned to the starting conditions, which were held for 16 days. All of the transponders were then retested. The results of the retesting are indicated as “Final” in Table 1. Numbers in parentheses are the percentage of transponders that became inactive under test conditions but then regained activity after standing for 16 days at the starting conditions.

TABLE 1

| Number of cycles | C1 | 2 | 3 | 4 | C5 |
|---|---|---|---|---|---|
| 1 | 100 | 100 | 100 | 100 | 40 |
| 3 | 98 | 100 | 100 | 100 | 40 |
| 10 | 82 | 96 | 96 | 100 | 40 |
| 18 | 76 | 76 | 94 | 100 | 0 |
| 21 | 76 | 72 | 94 | 100 | — |
| 27 | 68 | 64 | 84 | 100 | — |
| 42 | 60(2) | 56(8) | 76(0) | 98 | 0(0) |
| 51 | 48 | 48 | 76 | 98 | — |
| 60 | 38 | 44 | 72 | 96 | — |
| 72 | 24(6) | 36(8) | 72(4) | 94(0) | 0(0) |
| 87 | 22 | 28 | 64 | 92 | — |
| Final | 22(8) | 28(12) | 64(12) | 92(0) | 0(0) |

Table 1 shows that compositions comprising ethylene copolymers with polar comonomers provide superior performance compared to a high density polyethylene (HDPE) composition (C1). A blend of ethylene/butylacrylate with HDPE (Example 4) was particularly effective as an overmolding composition.

### COMPARATIVE EXAMPLES C6-C7

Fifty transponder assemblies were overmolded with a composition comprising 30 weight % of a polyetherester block copolymer thermoplastic elastomer (available from DuPont under the trademark Hytrel® 3078) and 70 weight % barium sulfate blend and tested as described above (Comparative Example C6). Five un-encapsulated transponders were also tested as controls (Comparative Example C7). Table 2 shows the percentage of active transponders remaining after the indicated number of cycles. Table 3 indicates the total transponder failures and the number of permanent failures (those that did not regain activity after removal from the test conditions) for the transponders of Comparative Example C6. In Table 2 and in subsequent Tables, “NT” means “not tested”.

TABLE 2

| Cycles | C6 | C7 |
|---|---|---|
| 1 | 92 | 80 |
| 5 | 78 | 60 |
| 8 | 66 | 60 |
| 10 | 54 | 20 |
| 19 | 44 | 20 |
| 22 | 44 | 20 |
| 25 | 40 | 20 |
| 28 | 30 | 20 |
| 31 | 24 | 20 |
| 40 | 22 | 0 |
| 43 | 18 | NT |
| 46 | 16 | NT |
| 49 | 14 | NT |
| 52 | 12 | NT |
| 61 | 10 | NT |
| 85 | 10 | NT |

TABLE 3

| | Total | Permanent |
|---|---|---|
| Cycles | Failures | Failures |
| 1 | 4 | — |
| 4 | 10 | 6 |
| 7 | 16 | 8 |
| 10 | 22 | 10 |
| 19 | 27 | 10 |
| 22 | 29 | 10 |
| 25 | 31 | 10 |
| 28 | 36 | 13 |
| 31 | 38 | 14 |
| 40 | 39 | 14 |
| 43 | 41 | 15 |
| 46 | 42 | 15 |
| 49 | 43 | 16 |
| 52 | 45 | 18 |
| 61 | 45 | 18 |
| 82 | 45 | 18 |

### COMPARATIVE EXAMPLES C8-C9

Table 4 shows the percentage of active transponders remaining after the indicated number of cycles for fifty transponders overmolded with the same copolyetherester/barium sulfate blend as Comparative Example C6, but using different transponder circuits, and tested as described above (Comparative Example C8). Five unencapsulated transponders were also tested as controls (C9).

TABLE 4

| Cycles | C8 | C9 |
|---|---|---|
| 1 | 92 | 20 |
| 3 | 90 | 20 |
| 7 | 80 | 20 |
| 11 | 68 | 0 |
| 14 | 60 | NT |
| 17 | 54 | NT |

### COMPARATIVE EXAMPLES C10-C11

Table 5 shows the percentage of active transponders remaining after the indicated number of cycles for fifteen transponders overmolded with the same copolyetherester/barium sulfate blend as Comparative Example C6, but using different transponder circuits, and tested as described above (Comparative Example C10). Seven un-encapsulated transponders were also tested as controls (C11).

TABLE 5

| Cycles | C10 | C11 |
|---|---|---|
| 1 | 100 | 100 |
| 4 | 100 | 100 |
| 7 | 100 | NT |
| 10 | NT | NT |
| 16 | 100 | NT |
| 19 | 100 | NT |
| 22 | 87 | 71 |
| 25 | 87 | 71 |
| 43 | 87 | NT |

Comparison of the data in Table 2 with the data in Tables 4 and 5 shows that compositions comprising ethylene copolymers, particularly Example 4, provided superior performance over a copolyetherester/barium sulfate blend.

### COMPARATIVE EXAMPLES C12-C14

Fifteen transponders were overmolded with the same HDPE-1 as Comparative Example C1 (Comparative Example C12) and fifteen transponders overmolded with the HDPE-1/EBA-7 blend used in Example 4 (Example 13). Five un-encapsulated transponders were also tested as controls (Comparative Example C14). The transponders were immersed in a solution that approximates the gastric juices present in the stomach of ruminants such as cows and sheep. Table 6 shows the composition of this solution.

TABLE 6
Gastric Juice Simulant

| Ingredient | g/3 Liters |
|---|---|
| NH₄OH (as 29% NH₃) | 1.23 |
| Acetic Acid | 14.41 |
| Propionic Acid | 6.3 |
| Butyric Acid | 5.4 |
| Water | 2972.3 |

The gastric juice simulant was heated at 105° F. The bolus transponders were evaluated as described above after a number of days of immersion. The results are set forth in Table 7, below, as the percentage of active transponders remaining after the indicated number of days.

TABLE 7
Gastric Juice Simulant Soak Test
% Active (Number inactive)

| Days at 105° F. | C12 | 13 | C14 |
|---|---|---|---|
| 1 | 100 (0) | 100 (0) | 80 (1) |
| 4 | 100 (0) | 100 (0) | 20 (4) |
| 7 | 100 (0) | 100 (0) | 0 (5) |
| 14 | 100 (0) | 100 (0) | |
| 21 | 87 (2) | 100 (0) | |
| 28 | 80 (3) | 100 (0) | |
| 35 | 80 (3) | 100 (0) | |
| 42 | 80 (3) | 100 (0) | |
| 49 | 80 (3) | 100 (0) | |
| 56 | 67 (5) | 100 (0) | |
| 63 | 53 (7) | 100 (0) | |
| 77 | 47 (8) | 93 (1) | |
| 91 | 47 (8) | 93 (1) | |
| 105 | 47 (8) | 93 (1) | |
| 119 | 33 (10) | 93 (1) | |
| 133 | 33 (10) | 93 (1) | |

The data in Table 7 show that the overmolding composition of Examples 4 and 13 provides markedly superior performance compared to the high density polyethylene (HDPE) overmolding composition of Comparative Examples C1 and C12.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. An overmolded transponder comprising a transponder that is at least partially overmolded with an overmolding composition;
wherein the overmolding composition comprises or is produced from at least one ethylene copolymer, wherein the ethylene copolymer comprises repeat units derived from ethylene and at least one comonomer; the at least one comonomer includes one or more comonomers selected from the group consisting of C₃ to C₈ α,β-ethylenically unsaturated carboxylic acid, alkyl (meth)acrylate, vinyl acetate, carbon monoxide, maleic acid monoester, and maleic acid diester.

2. The overmolded transponder of claim 1, wherein the C₃ to C₈ α,β-ethylenically unsaturated carboxylic acid comprises (meth)acrylic acid.

3. The overmolded transponder of claim 1, wherein the overmolding composition further comprises a blending polymer; wherein the blending polymer is different from the ethylene copolymer; and
further wherein the blending polymer comprises or is produced from polypropylene or polyethylene, or wherein the blending polymer comprises repeat units derived from ethylene and at least one comonomer; the at least one comonomer includes one or more comonomers selected from the group consisting of C₃ to C₈ α,β-ethylenically unsaturated carboxylic acid, alkyl (meth)acrylate, vinyl acetate, carbon monoxide, maleic acid monoester, and maleic acid diester.

4. The overmolded transponder of claim 3, wherein the blending polymer comprises a C₃ to C₈ α,β-ethylenically unsaturated carboxylic acid, and the C₃ to C₈ α,β-ethylenically unsaturated carboxylic acid comprises (meth)acrylic acid.

5. The overmolded transponder of claim 1, wherein the overmolding composition further comprises a filler.

6. The overmolded transponder of claim 5, wherein the filler is selected from the group consisting of barium sulfate, zinc oxide, calcium carbonate, titanium dioxide, carbon black, kaolin, magnesium aluminum silicate, silica, iron oxide, glass spheres, wollastonite, and combinations of two or more of barium sulfate, zinc oxide, calcium carbonate, titanium dioxide, carbon black, kaolin, magnesium aluminum silicate, silica, iron oxide, glass spheres, or wollastonite.

7. The overmolded transponder of claim 2 wherein the overmolding composition comprises barium sulfate; the ethylene copolymer comprises repeat units derived from an alkyl (meth)acrylate comonomer and a (meth)acrylic acid comonomer; the acid moieties of the ethylene copolymer are at least partially neutralized; and
further wherein the blending polymer comprises or is produced from polyethylene or high-density polyethylene.

8. The overmolded transponder of claim 2 comprising high-density polyethylene and an ionomer of ethylene/(meth)acrylic acid/alkyl (meth)acrylic acid.

9. The overmolded transponder of claim 8 wherein the alkyl group in the alkyl (meth)acrylate has from one to eight carbon atoms.

10. The overmolded transponder of claim 9 wherein the alkyl group is a methyl, an ethyl, or an n-butyl group.

11. The overmolded transponder of claim 10 wherein the residues of the alkyl (meth)acrylate comonomer are present in an amount of at least about 0.1, 5, or 10 weight percent, based on the total weight of the ethylene copolymer.

12. The overmolded transponder of claim 10 wherein the residues of the alkyl (meth)acrylate comonomer are present in an amount of up to about 28, 35, or 45 weight percent, based on the total weight of the ethylene copolymer.

13. The overmolded transponder of claim 1 wherein the transponder comprises ferrite, powdered metal, or magnet core materials and associated circuitry.

14. The overmolded transponder of claim 1, wherein the transponder comprises an antenna, a transponder circuit, a core element, and an overmolded casing; the transponder circuit comprises signal processing circuitry electrically interconnected to the antenna; and
the antenna and the transponder circuit are mounted on the core element.

15. The overmolded transponder of claim 14 wherein the core element comprises or is produced from a frangible material forming a frangible core.

16. The overmolded transponder of claim 15 wherein the frangible core comprises or is produced from a ferrite, a powdered metal, a high energy product magnet, or a combinations of two or of a ferrite, a powdered metal, and a high energy product magnet.

17. The overmolded transponder of claim 16 comprising the high energy product magnet, and wherein the high energy product magnet preferably comprises samarium, cobalt, neodymium, iron, boron, an alloy of two or more thereof, or a combination of two or more thereof.

18. The overmolded transponder of claim 1 that is a bolus transponder.

19. An electronic identification system wherein the overmolded transponder of claim 1 is placed within an animal thereby serving as a marker device to identify the animal.
